(19) United States
(12) Patent Application Publication
(10) Pub. No.: US 2006/0157258 A1
(43) Pub. Date: Jul. 20, 2006

(54) Fire extinguisher can

(76) Inventor: Ching-Huan Lin, Tali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/034,816

(22) Filed: Jan. 14, 2005

(51) Int. Cl. A62C 13/00

(52) U.S. Cl. 169/73; 169/30; 169/71; 169/85; 239/320; 239/323; 222/402.1; 222/386.5

(57) ABSTRACT

A fire extinguisher can is disclosed to include a metal can, a cap sealed to the bottleneck of the metal can, a jet-nozzle valve installed in the cap, an airtight bag suspending inside the metal can and connected to the jet-nozzle valve, a fire extinguishing agent filled in the airtight bag, a control button capped on the jet-nozzle valve for pressing by the user to let the fire extinguishing agent be ejected out of the airtight bag through the jet-nozzle valve, and a gas filled in the metal can outside the airtight bag for forcing the fire extinguishing agent out of the airtight bag through the jet-nozzle valve upon opening of the jet-nozzle valve.

### BACKGROUND OF THE INVENTION

1. Field of the Invention

The present invention relates to fire extinguishers and more particularly, to a fire extinguisher can.

2. Description of the Related Art

A conventional fire extinguisher can generally comprises a metal can holding a fire extinguishing agent, and a cover capped on the metal can. The cover has a control valve through which compressed air is filled into the metal can. When the user pressed the control valve, the fire extinguishing agent comes with compressed air out of the metal can through the control valve. This structure of fire extinguisher can has numerous drawbacks as follows:

1. The storage fire extinguishing agent is kept in direct contact with the inside wall of the metal can, it will corrupt the metal can. In order to prevent corruption, the metal can must be made of anti-corruption metal, resulting in a high cost.

2. The ejection of the fire extinguishing agent is achieved by means of the discharging action of the compressed air. However, the internal pressure of the metal can will be reduced following the reduction of the amount of compressed air in the metal can.

3. Because the fire extinguishing agent is ejected out of the metal can with compressed air, ejected air will support firing, thereby lowering the fire extinguishing efficiency.

4. After the service of the fire extinguisher can, the metal can becomes useless and must be properly disposed of.

### SUMMARY OF THE INVENTION

The present invention has been accomplished under the circumstances in view. It is therefore the main object of the present invention to provide a fire extinguisher can, which keeps the inside wall of the metal can out of touch of the fire extinguishing agent. It is another object of the present invention to provide a fire extinguisher can, which is reclaimable. To achieve these and other objects of the present invention, the fire extinguisher can comprises a metal can, a cap sealed to the bottleneck of the metal can, a jet-nozzle valve installed in the cap, a fire extinguishing agent provided inside the metal can, and a control button capped on the jet-nozzle valve for pressing by the user to let the fire extinguishing agent be ejected out of the jet-nozzle valve, wherein an airtight bag is provided inside the metal can and connected to the jet-nozzle valve to hold the fire extinguishing agent inside the metal can, and a gas is filled in the metal can outside the airtight bag for forcing the fire extinguishing agent out of the airtight bag through the jet-nozzle valve upon opening of the jet-nozzle valve.

### BRIEF DESCRIPTION OF THE DRAWINGS

FIG. 1 is an exploded view of a fire extinguisher can according to the present invention.

FIG. 2 is another exploded view of the fire extinguisher can according to the present invention.

FIG. 3 is a sectional elevation of the fire extinguisher can according to the present invention.

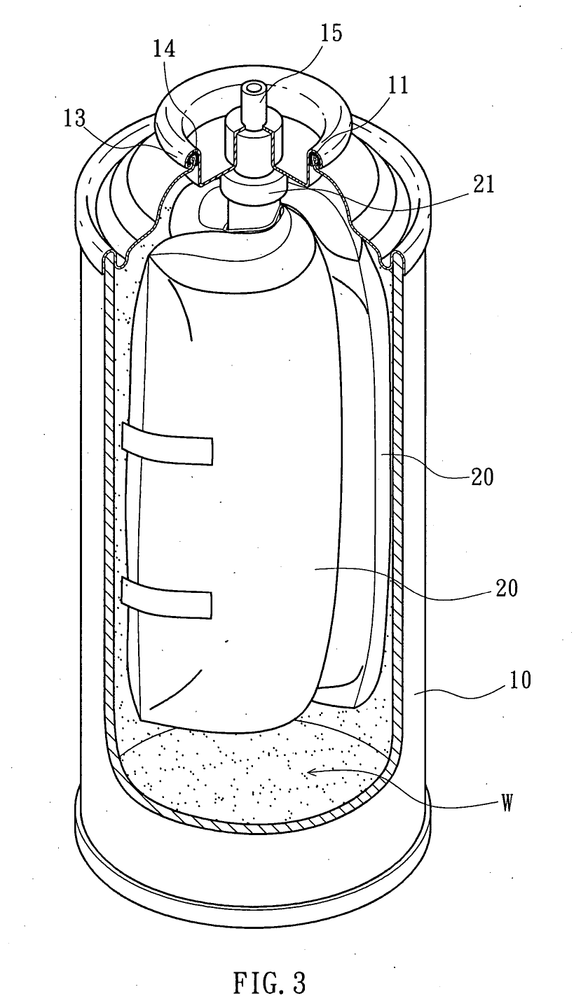

FIG. 4 is an elevational view of the fire extinguisher can according to the present invention.

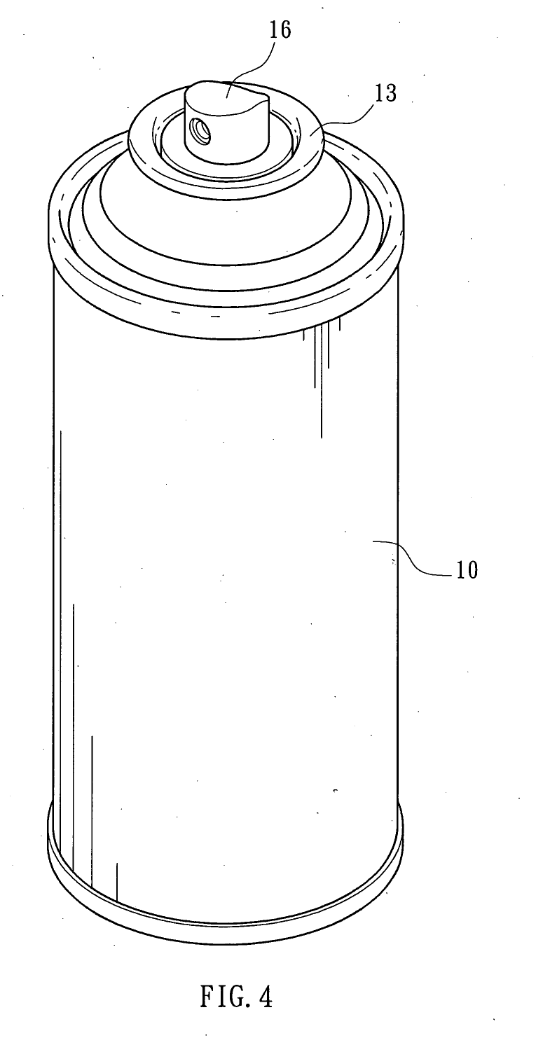

### DETAILED DESCRIPTION OF THE PREFERRED EMBODIMENT

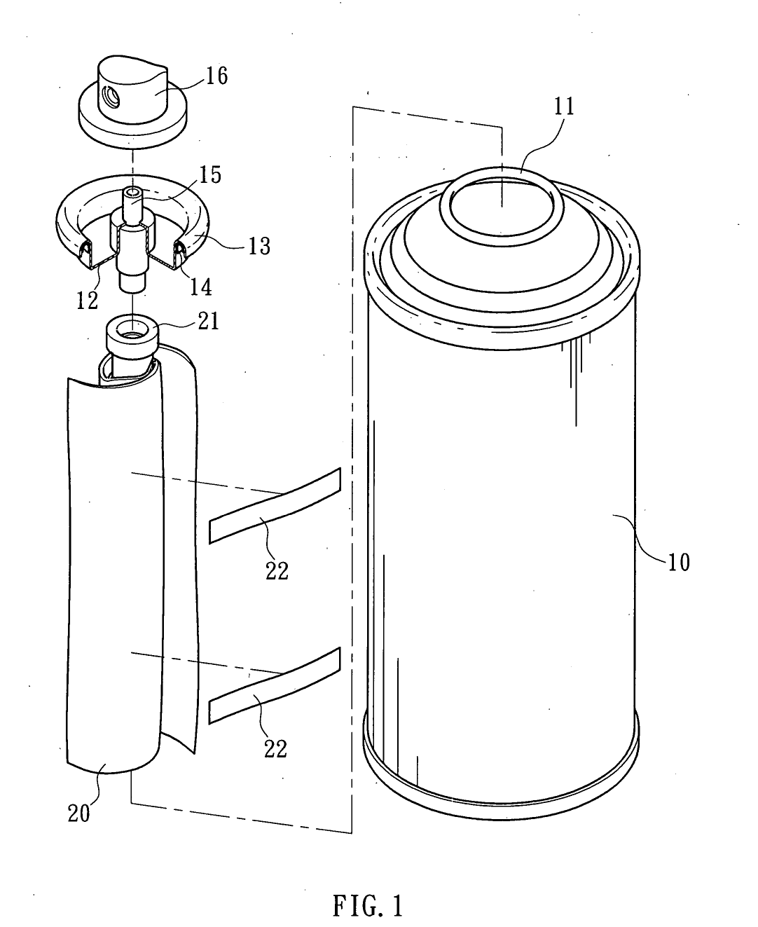

Referring to FIGS. 1˜4, a fire extinguisher can in accordance with the present invention is shown comprising a metal can 10, a cap 12 riveted to the bottleneck 11 of the metal can 10, a jet-nozzle valve 15 installed in the cap 12, and a control button 16 covered on the jet-nozzle valve 15 for pressing with the thumb to open the jet-nozzle valve 15.

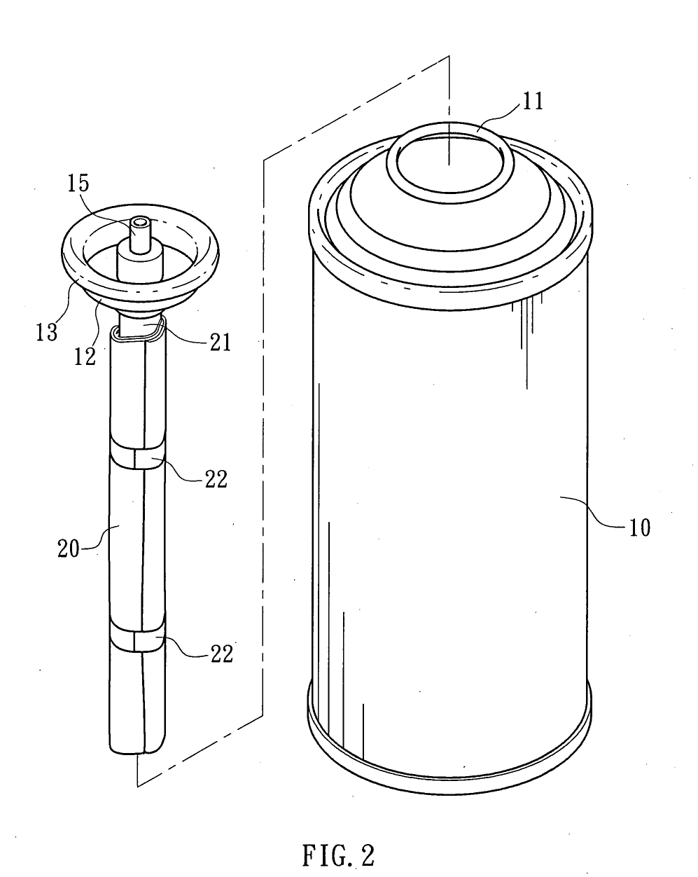

Further, an airtight bag 20 is provided at the bottom side of the cap 12 and inserted with the cap 12 into the inside of the metal can 10, having a connector 21 connected to the jet-nozzle valve 15. The airtight bag 20 holds a fire extinguishing agent. The metal can 10 is filled with compressed air W that gives a compressive force to the airtight bag 20 without contacting the fire extinguishing agent in the airtight bag 20. Before filling the fire extinguishing agent into the airtight bag 20, the empty airtight bag 20 is rolled up into a cylindrical shape as shown in FIG. 2, and then tied up with breakable strips 22. The airtight bag 20 is then inserted through the bottleneck 11 into the inside of the metal can 10. After insertion of the airtight bag 20 into the metal can 10, the rim 13 of the cap 12 is riveted to the metal can 10 to seal the bottleneck 11, and then the fire extinguishing agent is filled into the airtight bag 20 through the jet-nozzle valve 15, and finally the control button 16 is capped on the jet-nozzle valve 15. Further, a gasket ring 14 is set between the rim 13 of the cap 12 and the bottleneck 11 of the metal can 10 to prevent a leakage.

After filling of the fire extinguishing agent into the airtight bag 20, the airtight bag 20 is expanded to break the breakable strips 22 and simultaneously to compress the air inside the metal can 10 into a compressed air W.

When the user pressed the control button 16 to open the jet-nozzle valve 15, the compressed air W forces the fire extinguishing agent out of the airtight bag 20 through the jet-nozzle valve 15 to extinguish fire.

As indicated above, the invention has the following advantages:

1. The fire extinguishing agent is kept inside the airtight bag 20 without touching the inside wall of the metal can 10, therefore it is not necessary to use expensive anti-corruption metal material for making the metal can 10.

2. The fire extinguishing agent is forced out of the airtight bag 20 through the jet-nozzle valve 15 but not carried out of the airtight bag 20 by the compressed air W, the compressed air W is still kept inside the metal can 10 to compress the airtight bag 20 without supporting fire, and the fire extinguisher can can be reclaimed for a repeated use after a refurnish of the fire extinguishing agent.

3. The airtight bag 20 is tied up with the breakable strips 22 in the collapsed status convenient for insertion into the metal can 10 before filling of the fire extinguishing agent.

4. The compressed air W has a high pressure only when the airtight bag 20 is fully filled with the fire extinguishing agent. After the fire extinguishing agent has been used up, the volume of the airtight bag 20 is reduced, and the pressure inside the metal can 10 becomes approximately equal to the atmospheric pressure and will not cause an explosion.

5. The gasket ring 14 is provided between the rim 13 of the cap 12 and the bottleneck 11 of the metal can 10 to prevent a leakage.

A prototype of fire extinguisher can has been constructed with the features of the annexed drawings of FIGS. 1˜4. The fire extinguisher can functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A fire extinguisher can comprising a metal can, said metal can having a bottleneck, a cap sealed to said bottleneck, a jet-nozzle valve installed in said cap, a fire extinguishing agent provided inside said metal can, and a control button capped on said jet-nozzle valve for pressing by the user to let said fire extinguishing agent be ejected out of said jet-nozzle valve, wherein an airtight bag is provided inside said metal can and connected to said jet-nozzle valve to hold said fire extinguishing agent inside said metal can, and a gas is filled in said metal can outside said airtight bag for forcing said fire extinguishing agent out of said airtight bag through said jet-nozzle valve upon opening of said jet-nozzle valve.

2. The fire extinguisher can as claimed in claim 1, wherein further comprising at least one breakable strip for tying said airtight bag in a collapsed status for insertion through said bottleneck into said metal can before filling of said fire extinguishing agent into said airtight bag.

3. The fire extinguisher can as claimed in claim 1, further comprising a gasket ring provided between said cap and said bottleneck to seal the gap.
